(19) United States
(12) Patent Application Publication
(10) Pub. No.: US 2013/0333527 A1
(43) Pub. Date: Dec. 19, 2013

(54) Tool Extension Bar

(71) Applicant: HONG ANN TOOL INDUSTRIES CO., LTD., Taichung (TW)

(72) Inventor: Cheng-Wei Su, Taichung (TW)

(73) Assignee: Hong Ann Tool Industries Co., Ltd., Taichung (TW)

(21) Appl. No.: 13/711,863

(22) Filed: Dec. 12, 2012

(30) Foreign Application Priority Data
Jun. 14, 2012 (TW) 101121345

(51) Int. Cl. B25B 23/00

(52) U.S. Cl. CPC B25B 23/0007
USPC 81/177.2

(57) ABSTRACT

A tool extension bar includes a rod including first and second ends. The second end is adapted to connect to and be driven by a power tool. A positioning bore is formed at the rod to receive a positioning assembly. A sleeve is slidably mounted around the rod and includes an end adapted for connecting to a tool member. A coupling hole extends through the sleeve. A radial hole extends from an outer periphery of the sleeve through an inner periphery of the coupling hole. The positioning assembly constantly abuts against the inner periphery of the coupling hole. An engaging member is movably received in the radial hole and is moveably engaged in the recess of the rod. The engaging member releasably engages the sleeve with the rod.

### BACKGROUND OF THE INVENTION

1. Field of the Invention

The present invention relates to a tool extension bar and, more particular, to a tool extension bar suitable to have an application with a power tool and adapted to be connected to or disconnected from a tool member, such as a socket.

2. Description of the Related Art

U.S. Pat. No. 8,070,377 discloses a tool extension bar including a rod, a sleeve, a ball, and a spring. The rod has first and second sections. The first section of the rod includes an end for coupling with a pneumatic tool, and the second section of the rod extends from the other end of the first section. The sleeve is slideably mounted around the rod and includes an end for releasably coupling a bit. The sleeve includes an axial bore having larger and smaller sections. The larger section of the sleeve has polygonal cross sections corresponding to polygonal cross sections of the first section. A radial bore is formed in the sleeve and in communication with the smaller section. The ball is moveably received in the radial bore and moveably received in a recess of the second section of the rod to releasably engage the sleeve with the bit. The spring is mounted in the larger section of the axial bore of the sleeve and biases the sleeve from the retracted, second position to the extended, first position. The ball is engaged in the first contact section of the recess with an outermost portion of the ball projecting out of the radial bore of the sleeve when the sleeve is in the extended, first position, coupling the bit with the second end of the sleeve. The ball is engaged in the second contact section of the recess and not projecting out of the radial bore of the sleeve when the sleeve is in the retracted, second position, allowing the bit to be disengaged from the second end of the sleeve.

However, when the tool extension bar used with the pneumatic tool has some disadvantages. The pneumatic tool driven by a gas, usually compressed air supplied by a gas compressor will certainly create vibration in operation. Thus, the spring is repeatedly retracted and extended to cause the sleeve changed from the first position to the second position. Therefore, the bit will disengaged from the second end of the sleeve unintentionally.

Moreover, if the fit clearance formed between the sleeve and the rod too large results in the rod swaying with respect to the sleeve in operation, it even causes the sleeve changed from the first position to the second position unintentionally too.

The present invention is, therefore, intended to obviate or at least alleviate the problems encountered in the prior art.

### SUMMARY OF THE INVENTION

The present invention solves this need and other problems in the field of extension bar by providing a tool extension bar including a rod body, a hollow sleeve slidably mounted around the rod body, a positioning assembly, and an engaging member. The rod body includes first and second ends spaced in an axial direction. A guide recess is formed adjacent to the first end of the rod body and includes a first contact section arranged adjacent to the first end of the rod body, and a second contact section extending toward the second end of the rod body from an end of the first contact section. The second end of the rod body is adapted to connect to and driven by a power tool. A shoulder portion is formed between the first and second ends. A positioning bore is formed at the shoulder portion in a radial direction perpendicular to the axial direction. The hollow sleeve is mounted around the rod body and slideable relative to the rod body in the axial direction between first and second positions. The hollow sleeve includes a first end adapted for connecting to a tool member, a second end spaced in the axial direction, and a coupling hole extending between the first and second ends of the hollow sleeve to mount around the rod body. A radial hole extends in the radial direction from an outer periphery of the first end of the hollow sleeve through an inner periphery of the coupling hole. The radial hole aligns to the guide recess of the rod body. The positioning assembly is received in the positioning bore of the rod body and constantly abutting against the inner periphery of the coupling hole. The engaging member is movably received in the radial hole of the hollow sleeve in the radial direction and moveably engaged in the guide recess of the rod body in the axial and radial directions. The engaging member releasably engages the hollow sleeve with the rod body.

Preferably, the shoulder portion includes top and bottom surfaces arranged at two opposite ends thereof. The coupling hole further includes at least one inclined recess to align with the positioning assembly.

In an example, the positioning includes a positioning element and an elastic element. The positioning element is a ball, and the elastic element is a spring.

In another example, the positioning bore of the rod body extends through the top and bottom surfaces of the shoulder portion. The coupling hole includes two inclined recesses respectively formed opposite with each other. The positioning assembly includes two positioning elements and an elastic element. Two opposite ends of the elastic element respectively abut against the two positioning elements engaging in the two inclined recesses of the coupling hole.

The two inclined recesses are formed by milling.

The two inclined recesses are formed by forging.

An advantage of the tool extension bar according to the present invention is that whether the hollow sleeve is moved to the first position or the second position, the positioning element is biased by the elastic element and constantly abuts against the inclined recess to avoid the rod body 10 arbitrarily swaying with respect to the hollow sleeve in operation.

Another advantage of the tool extension bar according to the present invention is that when the hollow sleeve is moved to the first position, the engaging member is engaged in the first contact section of the guide recess with the outermost portion of the engaging member projecting out of the radial hole of the hollow sleeve, engaging the tool member with the first end of the hollow sleeve. On the other hand, when the hollow sleeve is moved to the second position, the engaging member is engaged in the second contact section of the guide recess and does not project out of the radial hole of the hollow sleeve, allowing the tool member to be disengaged from the first end of the hollow sleeve.

The present invention will become clearer in light of the following detailed description of illustrative embodiments of this invention described in connection with the drawings.

### BRIEF DESCRIPTION OF THE DRAWINGS

The illustrative embodiments may best be described by reference to the accompanying drawings where:

FIG. 1 shows a perspective view of a tool extension bar of a first embodiment according to the present invention.

FIG. 2 shows an exploded, perspective view of the tool extension bar of FIG. 1.

FIG. 3 shows a cross-section view taken along line 3-3 of FIG. 1, and illustrates a sleeve located at a first position.

FIG. 4 shows a cross-section view taken along line 4-4 of FIG. 3.

FIG. 5 shows a continued, cross-section view of FIG. 3, and illustrates the sleeve located at a second position.

FIG. 6 shows a cross-section view of a tool extension bar of a second embodiment according to the present invention.

FIG. 7 shows a cross-section view of a tool extension bar of a third embodiment according to the present invention.

All figures are drawn for ease of explanation of the basic teachings only; the extensions of the figures with respect to number, position, relationship, and dimensions of the parts to form the illustrative embodiments will be explained or will be within the skill of the art after the following teachings have been read and understood. Further, the exact dimensions and dimensional proportions to conform to specific force, weight, strength, and similar requirements will likewise be within the skill of the art after the following teachings have been read and understood.

Where used in the various figures of the drawings, the same numerals designate the same or similar parts. Furthermore, when the terms “first”, “second”, “third”, “fourth”, “end”, “portion”, “longitudinal”, “radial”, “diameter”, “width”, “thickness”, and similar terms are used herein, it should be understood that these terms have reference only to the structure shown in the drawings as it would appear to a person viewing the drawings and are utilized only to facilitate describing the illustrative embodiments.

### DETAILED DESCRIPTION OF THE PREFERRED EMBODIMENTS

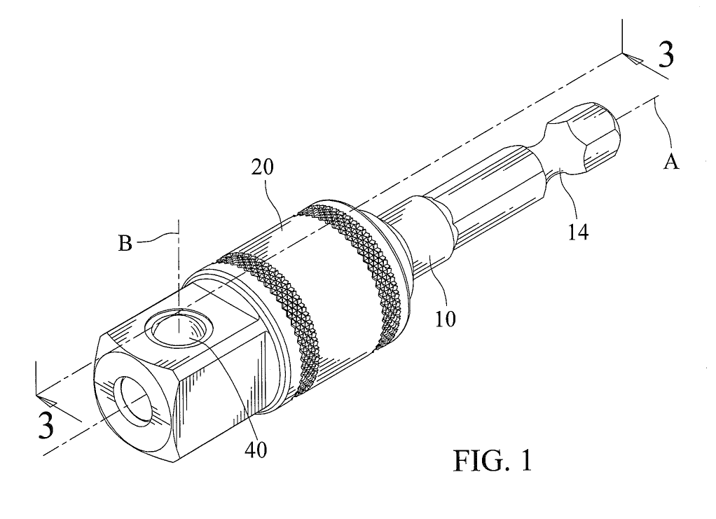

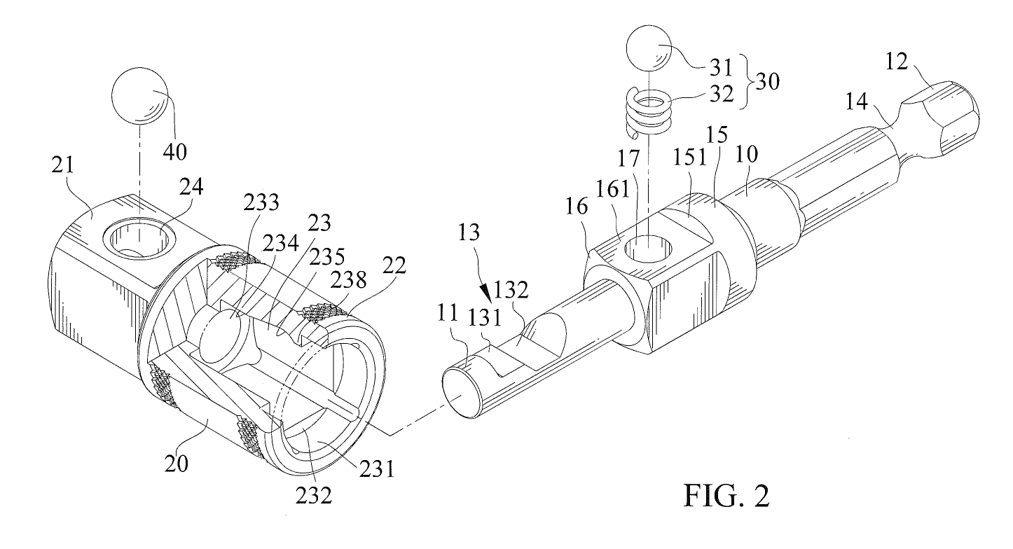

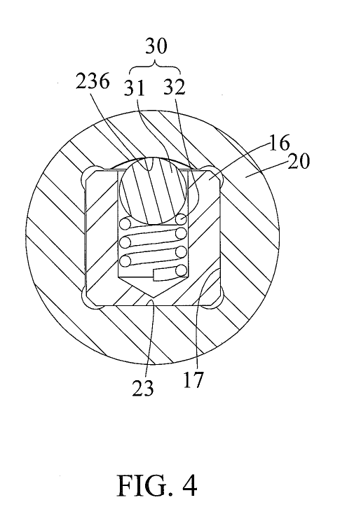

FIGS. 1 through 5 show a first embodiment of a tool extension bar according to the present invention shown in the drawings. The tool extension bar includes a rod body 10, a hollow sleeve 20 slidably mounted around the rod body 10, a positioning assembly 30, and an engaging member 40.

The rod body 10 includes a first end 11, a second end 12 spaced from the first end 11 along a first axis A, and a guide recess 13 formed adjacent to the first end 11. The first end 11 has a circular cross section, and the second end 12 has a hexagonal cross section greater than the circular cross section of the first end 11. The guide recess 13 has a first contact section 131 arranged adjacent to the first end 11 of the rod body 10, and a second contact section 132 extending toward the second end 12 of the rod body 10 from an end of the first contact section 131 opposite to the first end 11 of the rod body 10. A first height H1 defined from the first contact section 131 to the first axis A in a radial direction perpendicular to the first axis A is greater than a second height H2 defined from the second contact section 132 to the first axis A in the radial direction. Namely, the first contact section 131 having a depth in the radial direction perpendicular to the first axis A is less than that of the second contact section 132. An annular groove 14 is formed circumferentially at an outer periphery of the second end 12 of the rod body 10 and adapted to connect to and be driven by a power tool, such as a pneumatic tool, an electric tool, or an automated machine. The rod body 10 further includes a convex portion 15 formed between the first and second ends 11 and 12 thereof. The convex portion 15 has a circular cross section perpendicular to the first axis A and includes a first contact surface 151. Moreover, an outer diameter of the convex portion 15 is greater than that of the first and second ends 11 and 12 of the rod body 10. Additionally, a shoulder portion 16 is formed toward the first end 11 of the rod body 10 from the first contact surface 151 of the convex portion 15 and intermediate the convex portion 15 and the guide recess 13 along the first axis A. The shoulder portion 16 has a rectangular cross section perpendicular to the first axis A and includes top and bottom surfaces 161 and 162 arranged at two opposite ends thereof and connecting to the first contact surface 151. A width of the shoulder portion 16 is greater than outer diameters of the first and second ends 11 and 12 and less than the outer diameter of the convex portion 15. A positioning bore 17 is formed at the top surface 161 of the shoulder portion 16 in the radial direction perpendicular to the first axis A to receive the positioning assembly 30.

The hollow sleeve 20 is mounted circumferentially outside the rod body 10 and slideable relative to rod body 10 along the first axis A. The hollow sleeve 20 includes a first end 21 adapted for connecting to a tool member 50, such as a socket, a second end 22 spaced from the first end 21 along the first axis A, and a coupling hole 23 extending between the first and second ends 21 and 22 thereof to mount around the rod body 10. The coupling hole 23 includes a larger section 231, a smaller section 233, and a middle section 234 arranged between the larger and smaller sections 231 and 233 along the first axis A. The larger section 231 has a circular cross section perpendicular to the first axis A and corresponding to the circular cross section of the convex portion 15 of the rod body 10. The coupling hole 23 further includes a second contact surface 232 formed from an inner periphery thereof to a radial extent and selectively abutted against the first contact surface 151 of the convex portion 15. The smaller section 233 has a circular cross section perpendicular to the first axis A and corresponding to the first end 11 of the rod body 10. The middle section 234 has a rectangular cross section perpendicular to the first axis A and corresponding to the shoulder portion 16 of the rod body 10 to increase the joint stress between the rod body 10 and the hollow sleeve 20 to cause the rod body 10 adapted to connect to and be driven by a high torque power tool. The coupling hole 23 further includes an inclined recess 235 formed at the middle section 234 to align with the positioning assembly 30. The inclined recess 235 includes a first abutting section 236 and a second abutting section 237 extending toward the first end 11 of the rod body 10 from a terminal end of the first abutting section 236 along the first axis A. A first vertical distance L1 from the first abutting section 236 to the first axis A in the radial direction perpendicular to the first axis A is greater than a second vertical distance L2 from the second abutting section 237 to the first axis A in the radial direction. Thus, the inclined recess 235 is gradually shrunk from the first abutting section 236 to the second abutting section 237 along the first axis A. A distal end of the first abutting section 236 opposite to the second abutting section 237 extends toward the radial direction of the first axis A to form a resisting portion 238. Moreover, the hollow sleeve 20 further includes a radial hole 24 extending along a second axis B perpendicular to the first axis A from an outer periphery of the first end 21 of the hollow sleeve 20 through an inner periphery of the smaller section 233 of the coupling hole 23. The radial hole 24 aligns to the guide recess 13 of the rod body 10. In a preferred form, the first end 21 of the hollow sleeve 20 has a rectangular cross section perpendicular to the first axis A, and the second end 22 of the hollow sleeve 20 has a circular cross section perpendicular to the first axis A.

The positioning assembly 30 is received in the positioning bore 17 of the rod body 10 and includes a positioning element 31 and an elastic element 32. In a preferred form, the positioning element 31 is a ball, and the elastic element 32 is a spring. Two opposite ends of the positioning element 31 respectively abut against the inclined recess 235 of the coupling hole 23 and the elastic element 32. An end of the elastic element 32 opposite to the positioning element 31 abuts against a bottom of the positioning bore 17 of the rod body 10. In a preferred form, the elastic element 32 is a spring.

The engaging member 40 is movably received in the radial hole 24 of the hollow sleeve 20 along the second axis B. Moreover, the engaging member 40 is also moveably engaged in the first and second contact sections 131 and 132 of the guide recess 13 of the rod body 10 along the first and second axes A and B to releasably engage the hollow sleeve 20 with the rod body 10. In a preferred form, the engaging member 40 is a ball. A distal end of the radial hole 24 of the hollow sleeve 20 adjacent to the outer periphery of the first end 21 of the hollow sleeve 20 having an inner diameter is less than an outer diameter of the engaging member 40 to avoid the engaging member 40 disengaging from the radial hole 24 of the hollow sleeve 20 such that a outermost portion 41 of the engaging member 40 selectively projects out of the radial hole 24 of the hollow sleeve 20 to engage the hollow sleeve 20 with the tool member 50.

According to the preferred form shown, the tool member 50 is a socket and includes a connecting end 51 and a driving end 52. The connecting end 51 of the tool member 50 has a connecting hole 511 to receive the first end 21 of the hollow sleeve 20 and a connecting groove 512 formed at an inner periphery of the connecting hole 511 to selectively engage with the outermost portion 41 of the engaging member 40.

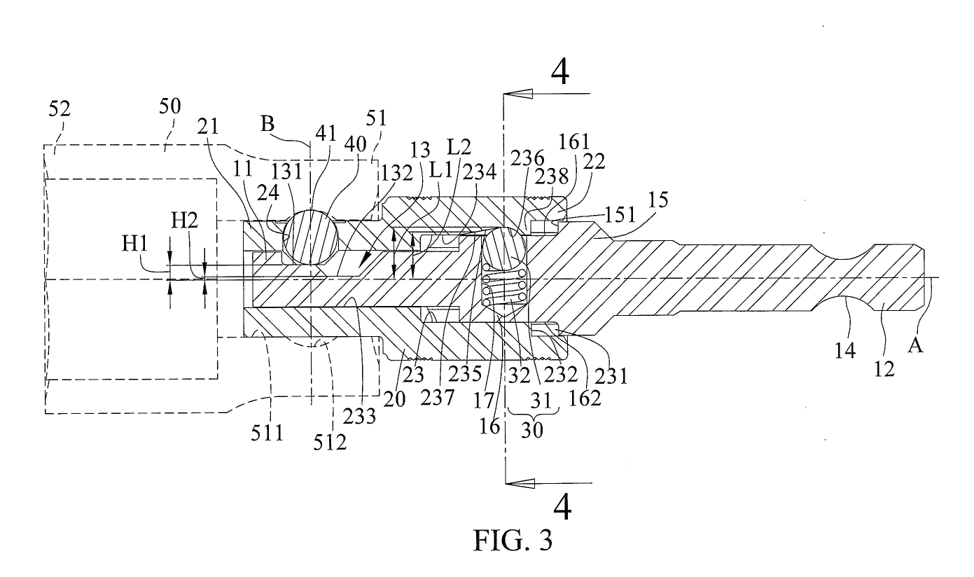

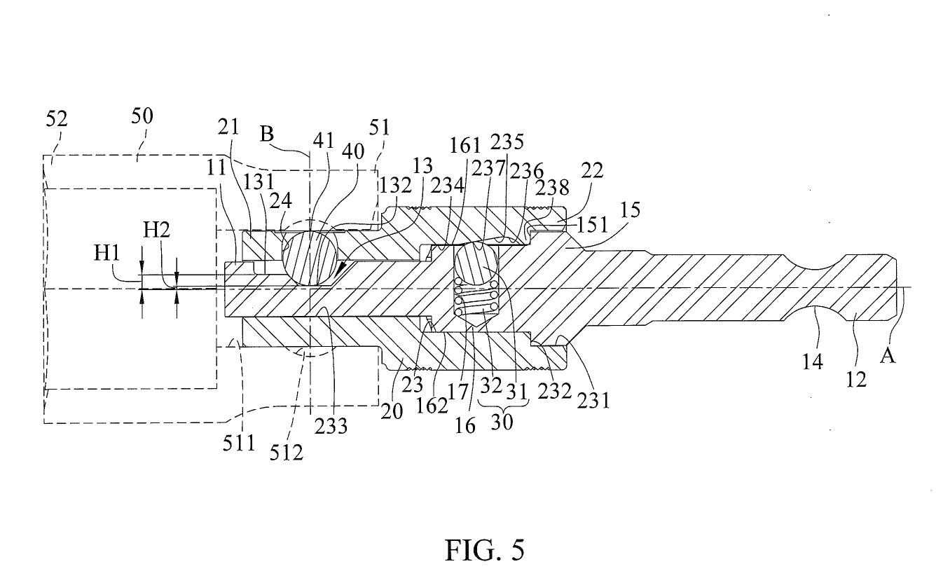

The hollow sleeve 20 is moveable relative to rod body 10 along the first axis A between a first position (shown in FIG. 3) and a second position (shown in FIG. 5). The elastic element 32 is compressed when the hollow sleeve 20 is in the second position.

When the hollow sleeve 20 is moved to the first position, the engaging member 40 is pushed by the radial hole 24 of the hollow sleeve 20 and engaged in the first contact section 131 of the guide recess 13. As mentioned above, the first contact section 131 has the depth in the radial direction perpendicular to the first axis A less than that of the second contact section 132. Thus, when the engaging member 40 is seated in the first contact section 131, the outermost portion 41 of the engaging member 40 projects out of the radial hole 24 of the hollow sleeve 20 and engages with the connecting groove 512 of the tool member 50. Therefore, the tool member 50 is securely locked on the tool extension bar as shown in FIG. 3 and can be driven when the rod body 10 of the tool extension bar secured to power tool rotates. Meanwhile, the positioning element 31 is biased by the elastic element 32. Thus, the positioning element 31 abuts against the first abutting section 236 of the inclined recess 235 and the resisting portion 238 to cause the bottom surface 162 of the shoulder portion 16 abutting closely against the middle section 234 of the coupling hole 23 of the hollow sleeve 20 to avoid the rod body 10 arbitrarily swaying with respect to the hollow sleeve 20 in operation.

Referring to FIG. 5, when the hollow sleeve 20 is moved to the second position, the engaging member 40 is pushed by the radial hole 24 of the hollow sleeve 20 and moved along the second axis B to engage in the second contact section 132 of the guide recess 13. As mentioned above, the outermost portion 41 of the engaging member 40 does not project out of the radial hole 24 of the hollow sleeve 20 and disengages from the connecting groove 512 of the tool member 50. Therefore, the tool member 50 is quickly unlocked on the tool extension bar as shown in FIG. 5. Meanwhile, the positioning element 31 is biased by the elastic element 32. Thus, the positioning element 31 abuts against the second abutting section 237 of the inclined recess 235 and is moved away the resisting portion 238 to cause the bottom surface 162 of the shoulder portion 16 still abutting closely against the middle section 234 of the coupling hole 23 of the hollow sleeve 20 to avoid the rod body 10 arbitrarily swaying with respect to the hollow sleeve 20 in operation.

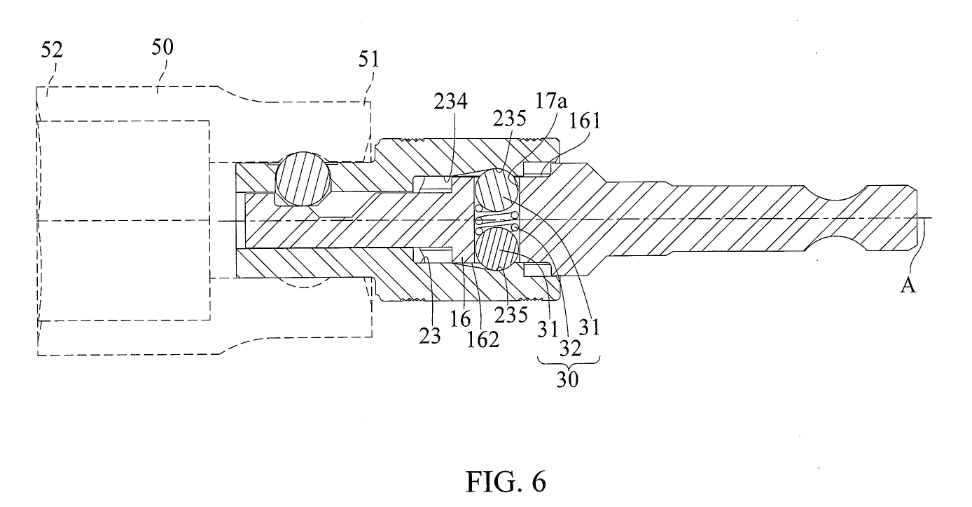

FIG. 6 shows a second embodiment of the tool extension bar according to the present invention shown in the drawing. The second embodiment is generally like the first embodiment except that the positioning bore 17a of the rod body 10 extends through the top and bottom surfaces 161 and 162 of the shoulder portion 16, and the coupling hole 23 further includes two inclined recesses 235 respectively formed at two opposite ends of the middle section 234. The two inclined recesses 235 are formed by milling. Additionally, the positioning assembly 30 includes two positioning elements 31 and an elastic element 32. Two opposite ends of the elastic element 32 respectively abut against the two positioning elements 31 engaging in the two inclined recesses 235 of the coupling hole 23.

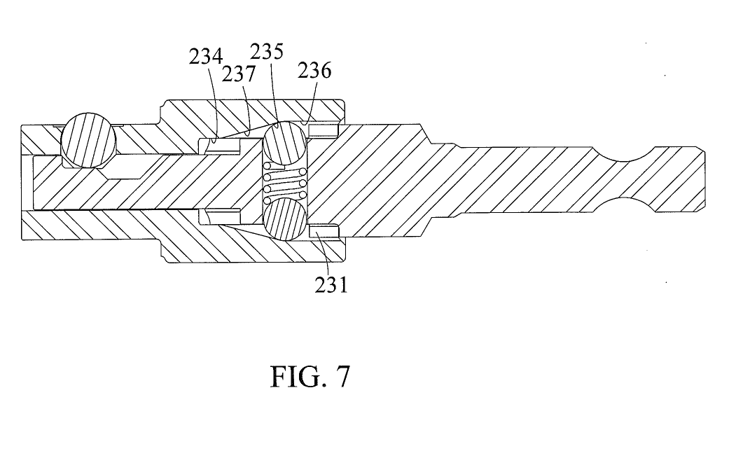

FIG. 7 shows a third embodiment of the tool extension bar according to the present invention shown in the drawing. Specifically, the two inclined recesses 235 formed by forging are different from that of the hollow sleeve 20 in FIG. 6. Thus, the two inclined recesses 235 are connected and communication with the larger section 231 of the coupling hole 23.

The tool extension bar includes the following advantages:

1. Whether the hollow sleeve 20 is moved to the first position or the second position, the positioning element 31 is biased by the elastic element 32 and constantly abuts against the inclined recess 235 to avoid the rod body 10 arbitrarily swaying with respect to the hollow sleeve 20 in operation.

2. When the hollow sleeve 20 is moved to the first position, the engaging member 40 is engaged in the first contact section 131 of the guide recess 13 with the outermost portion 41 of the engaging member 40 projecting out of the radial hole 24 of the hollow sleeve 20, engaging the tool member 50 with the first end 21 of the hollow sleeve 20. On the other hand, when the hollow sleeve 20 is moved to the second position, the engaging member 40 is engaged in the second contact section 132 of the guide recess 13 and does not project out of the radial hole 24 of the hollow sleeve 20, allowing the tool member 50 to be disengaged from the first end 21 of the hollow sleeve 20.

Thus since the illustrative embodiments disclosed herein may be embodied in other specific forms without departing from the spirit or general characteristics thereof, some of which forms have been indicated, the embodiments described herein is to be considered in all respects illustrative and not restrictive. The scope is to be indicated by the appended claims, rather than by the foregoing description, and all changes which come within the meaning and range of equivalency of the claims are intended to be embraced therein.

1. A tool extension bar comprising:
a rod body including first and second ends spaced in an axial direction, with a guide recess formed adjacent to the first end of the rod body and including a first contact section arranged adjacent to the first end of the rod body and a second contact section extending toward the second end of the rod body from an end of the first contact section, with the second end of the rod body adapted to connect to and be driven by a power tool, with a shoulder portion formed between the first and second ends, with a positioning bore formed at the shoulder portion in a radial direction perpendicular to the axial direction;
a hollow sleeve mounted around the rod body and slideable relative to the rod body in the axial direction between first and second positions, with the hollow sleeve including a first end adapted for connecting to a tool member, a second end spaced in the axial direction, and a coupling hole extending between the first and second ends of the hollow sleeve to mount around the rod body, with a radial hole extending in the radial direction from an outer periphery of the first end of the hollow sleeve through an inner periphery of the coupling hole, with the radial hole aligning to the guide recess of the rod body, with an inclined recess formed at the inner periphery of the coupling hole, with the inclined recess including first and second abutting sections with the inclined recess gradually shrinking from the first abutting section to the second abutting section;
a positioning assembly received in the positioning bore of the rod body and constantly abutting against the inclined recess of the inner periphery of the coupling hole; and
an engaging member movably received in the radial hole of the hollow sleeve in the radial direction and moveably engaged in the guide recess of the rod body in the axial and radial directions, with the engaging member releasably engaging the hollow sleeve with the rod body;
wherein with the hollow sleeve in the first position, the engaging member is pushed by the radial hole of the hollow sleeve and engaged in the first contact section of the guide recess, with an outermost portion of the engaging member projecting out of the radial hole of the hollow sleeve and engaging with the tool member, and with the positioning assembly abutting with the first abutting section of the inclined recess;
wherein with the hollow sleeve in the second position, the engaging member engages in the second contact section of the guide recess, with the outermost portion of the engaging member not projecting out of the radial hole of the hollow sleeve and disengaging from the tool member and with the positioning assembly abutting with the second abutting section of the inclined recess.

2. The tool extension bar as claimed in claim 1, wherein the second end of the rod body is spaced from the first end of the rod body along an axis, with a first height defined from the first contact section to the axis in the radial direction perpendicular to the axis greater than a second height defined from the second contact section to the axis in the radial direction perpendicular to the axis.

3. The tool extension bar as claimed in claim 2, wherein the first contact section has a depth in the radial direction perpendicular to the axis less than that of the second contact section, wherein when the engaging member is seated in the first contact section, the outermost portion of the engaging member projects out of the radial hole of the hollow sleeve, wherein when the engaging member is seated in the second contact section, the outermost portion of the engaging member does not project out of the radial hole of the hollow sleeve.

4. (canceled)

5. The tool extension bar as claimed in claim 2, wherein the coupling hole includes another inclined recess, with the inclined recesses respectively formed at two opposite ends of the inner periphery of the coupling hole, wherein with the hollow sleeve in the first position, the positioning assembly abuts against the first abutting section of each of the inclined recesses, wherein with the hollow sleeve in the second position, the positioning assembly abuts against the second abutting section of each of the inclined recesses.

6. The tool extension bar as claimed in claim 1, wherein the shoulder portion includes top and bottom surfaces arranged at two opposite ends thereof, with the positioning bore formed at the top surface of the shoulder portion, with the positioning assembly including a positioning element and an elastic element, with two opposite ends of the positioning element respectively abutting against the inclined recess of the coupling hole and the elastic element, with an end of the elastic element opposite to the positioning element abutting against a bottom of the positioning bore of the rod body.

7. The tool extension bar as claimed in claim 5, wherein the shoulder portion includes top and bottom surfaces arranged at two opposite ends thereof, with the positioning bore of the rod body extending through the top and bottom surfaces of the shoulder portion, with the positioning assembly including two positioning elements and an elastic element, with two opposite ends of the elastic element respectively abutting against the two positioning elements engaging in the inclined recesses of the coupling hole.

8. The tool extension bar as claimed in claim 2, wherein a first vertical distance from the first abutting section to the axis in the radial direction perpendicular to the axis is greater than a second vertical distance from the second abutting section to the axis in the radial direction, with the inclined recess gradually shrunk from the first abutting section to the second abutting section along the axis.

9. The tool extension bar as claimed in claim 5, wherein a first vertical distance from the first abutting section to the axis in the radial direction perpendicular to the axis is greater than a second vertical distance from the second abutting section to the axis in the radial direction, with the inclined recess gradually shrunk from the first abutting section to the second abutting section along the axis.

10. The tool extension bar as claimed in claim 6, wherein the positioning element is a ball, and wherein the elastic element is a spring.

11. The tool extension bar as claimed in claim 7, wherein the positioning element is a ball, and wherein the elastic element is a spring.

12. The tool extension bar as claimed in claim 2, wherein the rod body includes a convex portion formed between the first and second ends thereof, with the convex portion including a first contact surface, with an outer diameter of the convex portion being greater than that of the first and second ends of the rod body, with the coupling hole including a larger section, a smaller section, a middle section arranged between the larger and smaller sections along the axis, and a second contact surface formed from the inner periphery thereof to a radial extent and selectively abutted against the first contact surface of the convex portion.

13. The tool extension bar as claimed in claim 5, wherein the rod body includes a convex portion formed between the first and second ends thereof, with the convex portion including a first contact surface, with an outer diameter of the convex portion being greater than that of the first and second ends of the rod body, with the coupling hole including a larger section, a smaller section, a middle section arranged between the larger and smaller sections along the axis, and a second contact surface formed from the inner periphery thereof to a radial extent and selectively abutted against the first contact surface of the convex portion.

14. The tool extension bar as claimed in claim 12, wherein the shoulder portion is formed toward the first end of the rod body from the first contact surface of the convex portion and intermediate the convex portion and the guide recess along the axis, wherein the shoulder portion has a rectangular cross section perpendicular to the axis, with the middle section having a rectangular cross section corresponding to and receiving the shoulder portion of the rod body.

15. The tool extension bar as claimed in claim 13, wherein the shoulder portion is formed toward the first end of the rod body from the first contact surface of the convex portion and intermediate the convex portion and the guide recess along the axis, wherein the shoulder portion has a rectangular cross section perpendicular to the axis, with the middle section having a rectangular cross section corresponding to and receiving the shoulder portion of the rod body.

16. The tool extension bar as claimed in claim 12, wherein an outer diameter of the convex portion is greater than that of the first and second ends of the rod body, with a width of the shoulder portion greater than the outer diameters of the first and second ends of the rod body and less than the outer diameter of the convex portion.

17. The tool extension bar as claimed in claim 13, wherein an outer diameter of the convex portion is greater than that of the first and second ends of the rod body, with a width of the shoulder portion being greater than the outer diameters of the first and second ends of the rod body and less than the outer diameter of the convex portion.

18. The tool extension bar as claimed in claim 1, wherein an inner diameter of a distal end of the radial hole of the hollow sleeve adjacent to an outer periphery of the first end of the hollow sleeve is less than an outer diameter of the engaging member to avoid the engaging member disengaging from the radial hole of the hollow sleeve.

19. The tool extension bar as claimed in claim 1, wherein the first end of the rod body has a circular cross section, with the second end of the rod body having a hexagonal cross section of a size greater than the circular cross section of the first end of the rod body.
